(19) United States
(12) Patent Application Publication
(10) Pub. No.: US 2006/0144283 A1
(43) Pub. Date: Jul. 6, 2006

(54) Conduit traversing vehicle

(76) Inventor: Ernest Appleton, Durham (GB)

Correspondence Address: Jack Schwartz & Associates, Suite 1510, 1350 Broadway, New York, NY, 10018, US

(21) Appl. No.: 10/535,361

(22) PCT Filed: Nov. 18, 2003
(86) PCT No.: PCT/GB03/05019

§ 371 Date: Nov. 30, 2005

(30) Foreign Application Priority Data
Nov. 23, 2002 (GB) 0227383.7

(51) Int. Cl. B61B 13/10; B62D 51/06

(52) U.S. Cl. 104/138.1; 180/8.1; 15/104.05

(57) ABSTRACT

A conduit gripping apparatus (1) for a vehicle travelling along a conduit such as an oil pipeline is disclosed. The apparatus comprises a housing (2) having a plurality of surface engaging elements (3) carrying sets of resilient bristles (4). The bristles engage a surface of the conduit and resist relative movement of the corresponding surface engaging element (3) and the surface of the conduit in a first direction along the conduit more than in a second direction opposite to said first direction. Each surface engaging element is adapted to execute reciprocating movement, relative to the housing (2), having a component substantially parallel to said first and second directions, and not all of said surface engaging elements execute said reciprocating movement in phase with each other, such that the surface engaging elements remain in contact with the surface of the conduit during said reciprocating movement.

The present invention relates to vehicles for travelling along conduits having fluid flowing therein, and relates particularly, but not exclusively, to vehicles for travelling along liquid transportation pipelines having liquid flowing therein.

In many industries, particularly the oil and gas industry, it is desirable to have vehicles that can travel through pipelines to perform functions such as maintenance, repair and cleaning. Vehicles that are propelled in the direction of the fluid flow are well known.

A vehicle able to drive itself in a direction opposite to that of the fluid flow by means of the flowing fluid driving a turbine is disclosed in the applicant's international patent application no. PCT/GB00/03614. The vehicle described in PCT/GB00/03614 propels itself by having bodies provided with bristles which engage the walls of a conduit, and moves against the fluid flow using the turbine to power a reciprocating motion of the bodies towards and away from each other. This allows the vehicle to move against the fluid for an indefinite amount of time. This feature is useful in that the vehicle does not have to be connected to an umbilical power cable and can therefore travel through pipes of far greater length than in the prior art.

The vehicle described in PCT/GB00/03614 suffers from the drawback that each of the bodies provided with bristles does not move with generally uniform speed. As a result, the motion of a detector or like device mounted on the vehicle tends to be in the form of intermittent steps. That is, the vehicle takes a step along the pipe by virtue of one half reciprocation of the gripping members, and in the second half of the full reciprocation, the vehicle remains stationary whilst the gripping members reconfigure themselves for the next step.

This can be a particular disadvantage for example, when the vehicle is performing a scanning function. It is highly desirable to be able to scan lengths of the pipe wall at a generally constant rate. For example, it is much more straightforward to reconstruct a complete image of a scanned pipe from data collected by a vehicle moving at generally uniform speed.

WO 02/42601 discloses a bi-directional traction apparatus in which flow of fluid past a turbine causes rotation of a drive shaft, which in turn causes resilient arms of traction members to be oscillated or swashed backwards and forwards to move the apparatus along a pipeline. As a result of the oscillating/swashing movement of the traction members, the resilient arms of the traction members spend a significant proportion of the oscillating motion out of contact with the wall of the conduit. This arrangement therefore suffers from the drawback traction is not provided efficiently.

Preferred embodiments of the present invention seek to overcome the disadvantages of the prior art.

According to an aspect of the present invention, there is provided a conduit gripping apparatus comprising:

a body; and

a plurality of surface engaging elements, wherein each said surface engaging element is adapted to engage a surface of the conduit and resist relative movement of the element and the surface of the conduit in a first direction along the conduit more than in a second direction opposite to said first direction;

wherein each said surface engaging element is adapted to execute reciprocating movement, relative to the body, having a component substantially parallel to said first and second directions, and not all of said surface engaging elements execute said reciprocating movement in phase with each other, and wherein said surface engaging elements remain in contact with the surface of the conduit during said reciprocating movement.

By providing surface engaging elements, not all of which execute said reciprocating movement in phase with each other, this provides the advantage that the phases of the surface engaging elements can be staggered to make the velocity of a vehicle incorporating the conduit gripping apparatus as uniform as possible. In addition, by providing surface engaging elements which remain in contact with the surface of he conduit during reciprocating movement thereof, this provides the advantage of enabling traction to be provided more efficiently than in prior art apparatus.

In a preferred embodiment, a plurality of said surface engaging elements are resilient members.

A plurality of said resilient members are preferably bristles.

A plurality of said resilient members may be of elastomeric material.

Said resilient members may extend, when in an unstressed state, substantially perpendicularly to the direction of movement of the vehicle.

This provides the advantage that the resilient members can be inclined in either direction on insertion into a conduit, which enables the vehicle to be constructed in such a way that the inclination of the bristles can be reversed while the vehicle is in the conduit, in order to reverse the direction of travel of the vehicle.

A plurality of said surface engaging elements may be adapted to execute said reciprocating movements in a direction substantially parallel to an axis of the body.

In a preferred embodiment, the apparatus further comprises a shaft rotatably mounted to the body and engaging said surface engaging elements, such that rotation of the shaft relative to the body in use causes said reciprocating movement.

The apparatus may further comprise at least one engaging member provided on one of said shaft and a respective said surface engaging element, and at least one groove provided on the other of said shaft and said surface engaging element, wherein rotation of said shaft relative to said surface engaging elements causes movement of the or each said engaging member along the corresponding said groove to cause said reciprocating movement of the corresponding said surface engaging element.

In a further embodiment, a plurality of said surface engaging elements are retractable relative to the body.

The apparatus may further comprise a means for retracting said retractable elements.

Preferably, throughout the reciprocating motion, approximately half of said elements are moving in said first direction and substantially half in second direction relative to the body.

This has the advantage that the resultant traction force exerted on the conduit by a vehicle incorporating the conduit gripping apparatus to drive the vehicle forward is substantially uniform throughout the entire motion of the vehicle. This allows smoother movement at a substantially constant velocity.

At least one said surface engaging element may execute said reciprocating movement along a substantially straight line.

According to another aspect of the present invention, there is provided a vehicle for travelling in a conduit having fluid flowing therein, the vehicle comprising:

at least one conduit gripping apparatus as defined above;

drive means having a shaft adapted to be rotated relative to the or each said body as a result of flow of fluid relative thereto;

first surface engaging means mounted to the shaft for engaging a surface of the conduit and applying a gripping force thereto, such that said gripping force resists movement of the surface engaging means relative to the conduit more in one of said first or second direction than in the other of said first or second direction; and

connector means for causing said reciprocating movement of said surface engaging elements as a result of rotation of the shaft relative to the or each said body.

In a preferred embodiment, the vehicle derives the energy needed to propel itself from the fluid flow itself.

This has the advantage that no external power source is needed, and therefore no umbilical cord to provide power is needed. The vehicle can therefore travel in principle an indefinite distance against the flow of fluid.

The drive means may include at least one turbine.

As an aid to understanding the present invention, a preferred embodiment thereof will now be described, by way of example only and not in any limitative sense, with reference to the accompanying drawings, in which:

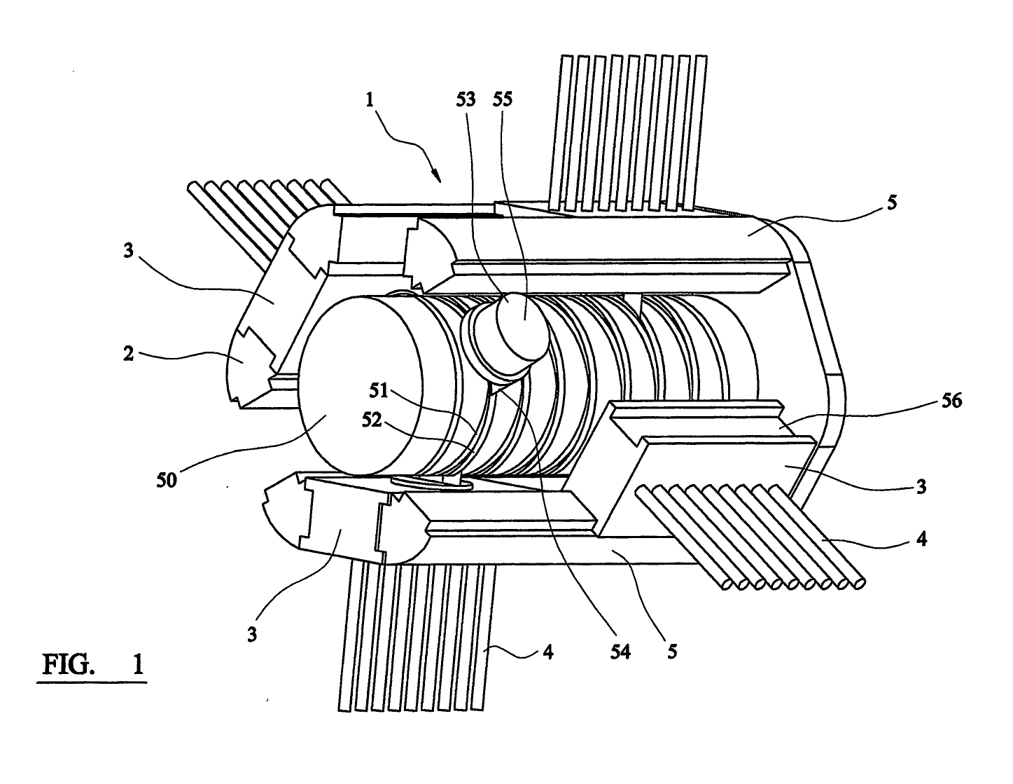

FIG. 1 is an exploded perspective view of a conduit gripping apparatus of a first embodiment of the present invention;

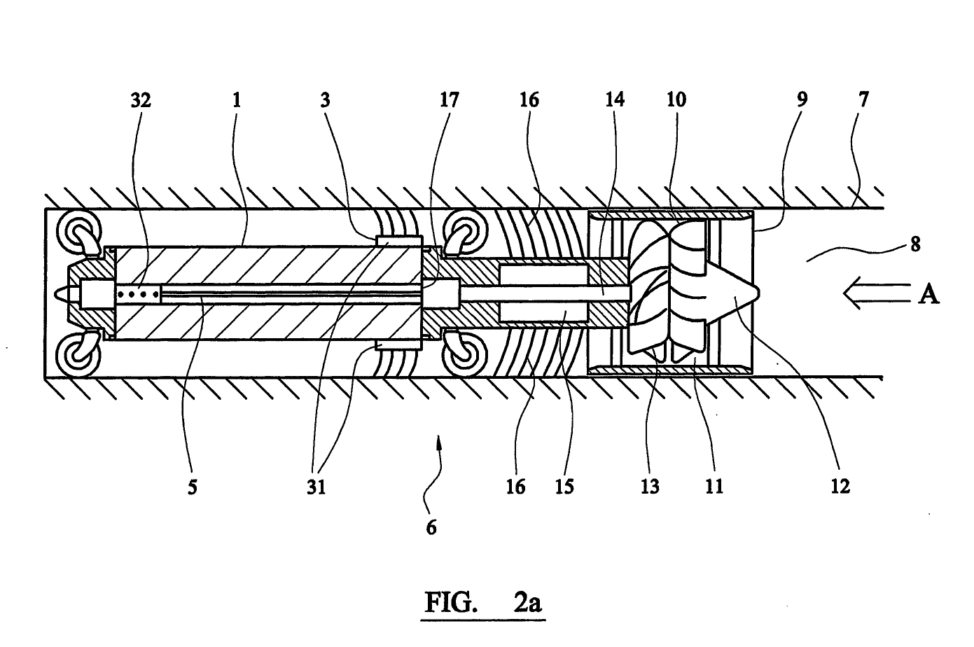

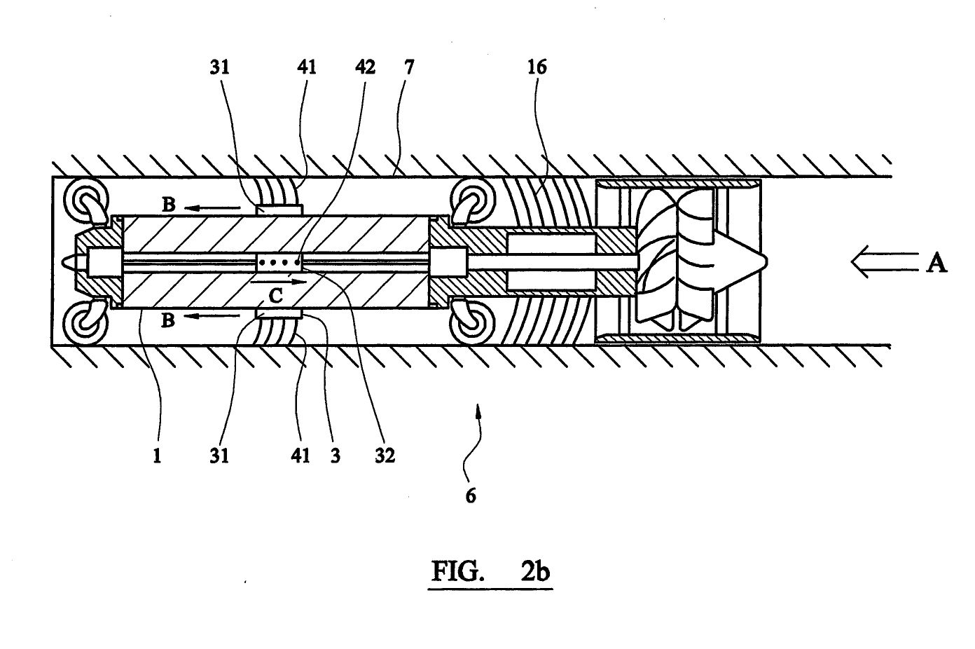

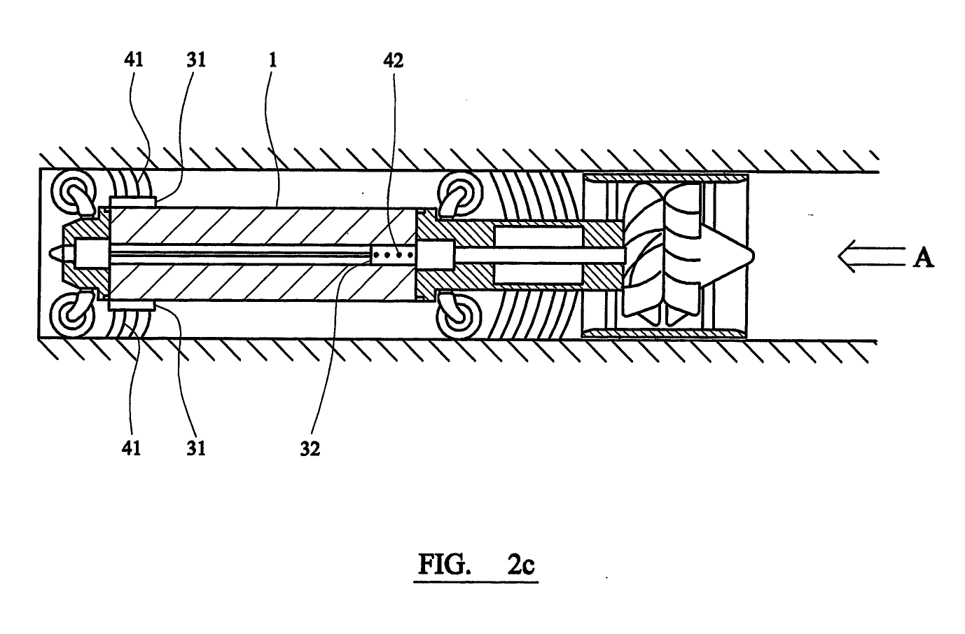

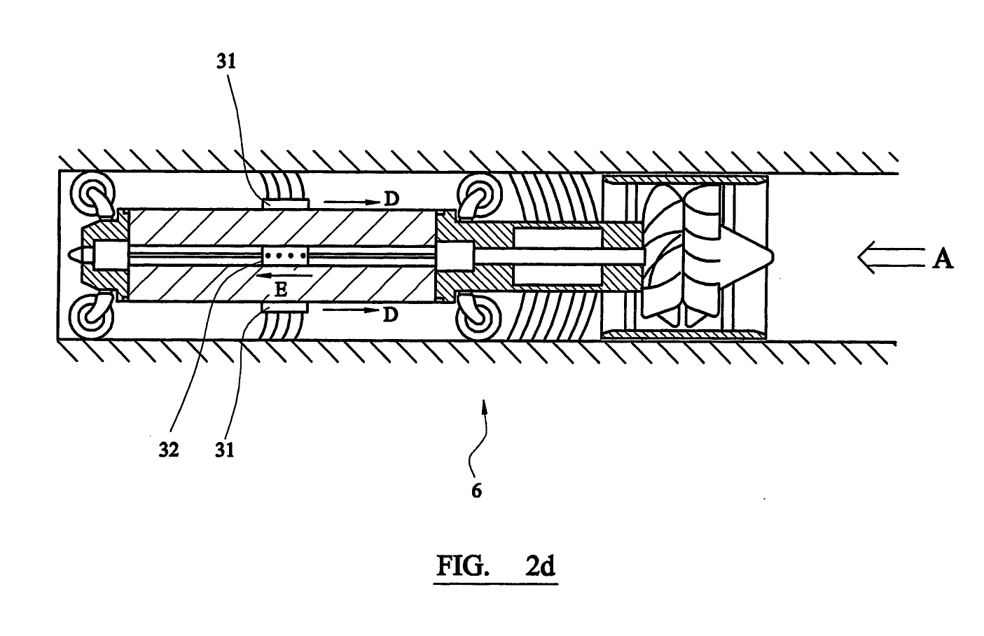

FIG. 2a is a schematic cross sectional view of a conduit traversing vehicle incorporating the conduit gripping apparatus of FIG. 1;

FIG. 2b is a schematic view, corresponding to FIG. 2a, in which the surface engaging elements of the conduit gripping apparatus have moved through one quarter of a full reciprocation from the position shown in FIG. 2a;

FIG. 2c is a schematic view, corresponding to FIG. 2a, in which the surface engaging elements have moved through one half of a full reciprocation from the position shown in FIG. 2a;

FIG. 2d is a schematic view, corresponding to FIG. 2a, in which the surface engaging elements have moved through three quarters of a full reciprocation from the position shown in FIG. 2a;

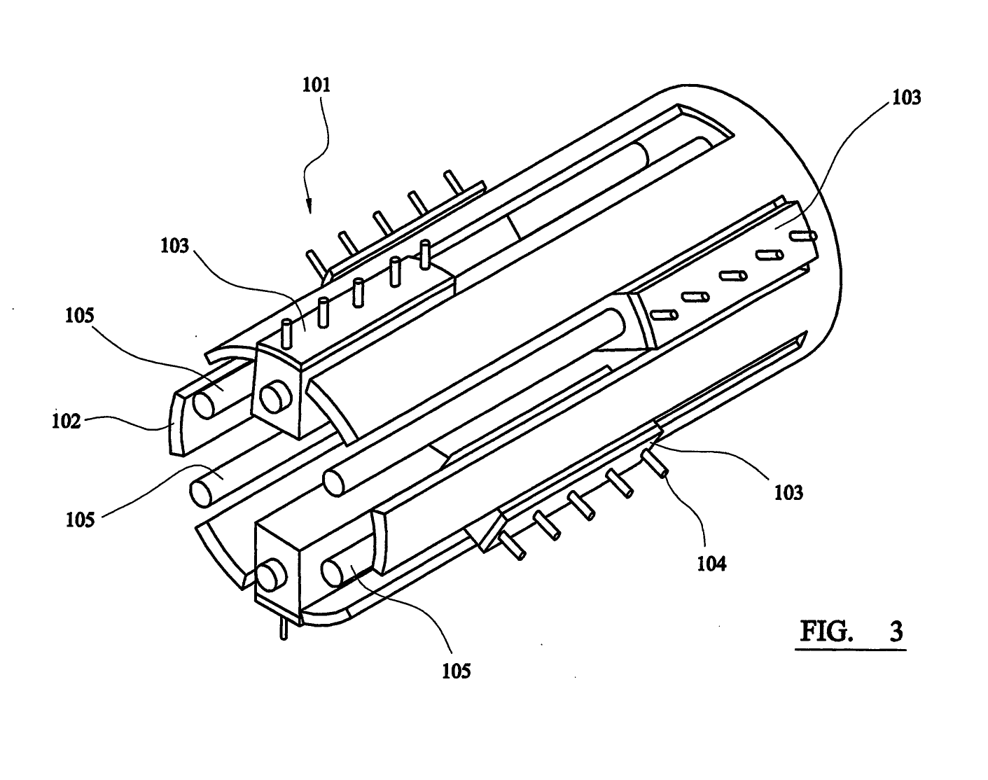

FIG. 3 is a detailed perspective view, corresponding to FIG. 1, of a conduit gripping apparatus of a second embodiment of the present invention; and

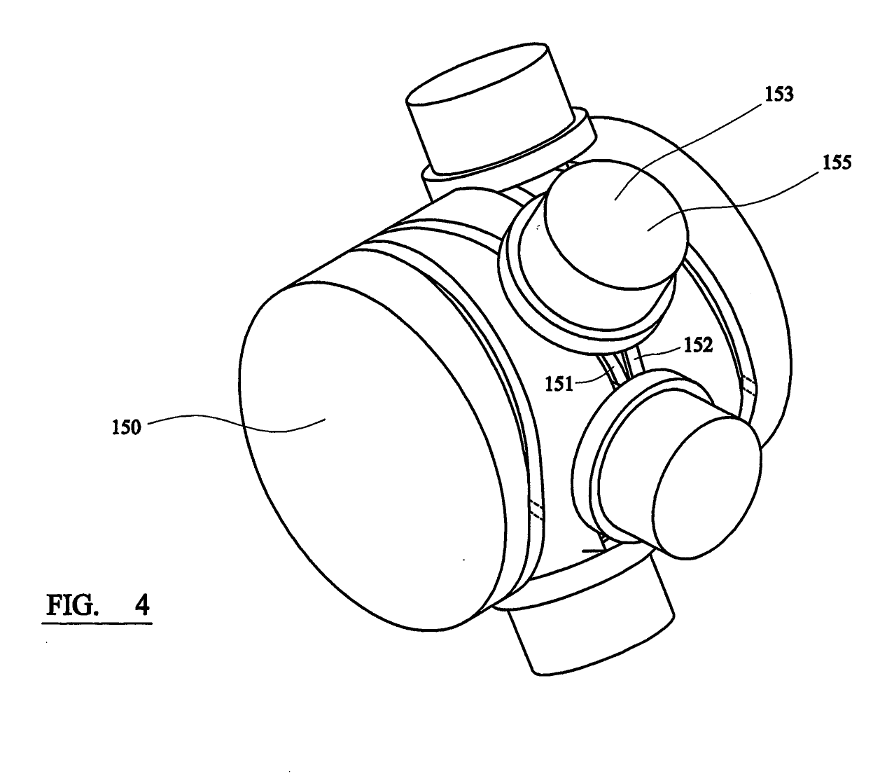

FIG. 4 is a perspective view of a reverse traverse screw and thread followers of the apparatus of FIG. 3.

Referring to FIG. 1, a conduit gripping apparatus 1 for engaging the inner walls of a conduit such as an oil pipeline, comprises a housing 2 with six surface engaging elements 3 carrying sets of resilient bristles 4 which extend generally perpendicularly to the longitudinal axis of the housing 2. The surface engaging elements 3 are spaced regularly in a circumferential direction around the housing 2 and slidingly engage guide rails 5 which are supported by the housing 2.

Each surface engaging element 3 is connected to a reverse traverse screw 50, by means of a thread follower 53. The reverse traverse screw 50 is provided with a pair of helical grooves 51, 52 long its length, and four thread followers 53, each of which has an elongate blade 54, for engaging one of the grooves 51, 52, and a cylindrical protrusion 55 for engaging a corresponding recess (not shown) in a respective surface engaging element 3. Each of the surface engaging elements 3 is provided with grooves 56 which mate with corresponding guide rails 5 so that rotation of the reverse traverse screw 50 causes the thread followers 53 to move along one of the grooves 51, 52 to cause reciprocating longitudinal sliding movement of each surface engaging element 3 along the pair of guide rails 5 adjacent thereto. The axial positions of the surface engaging elements 3 are arranged such that approximately half of the elements 3 are moving in one direction at any one time, while approximately half of the elements 3 are moving in the opposite direction.

Referring now to FIG. 2a, a vehicle 6 for travelling along a conduit 7, such as a pipeline having a fluid 8 such as oil flowing therein in the direction of arrow A, comprises a drive means 9 having a turbine 10 located within a housing 11. The turbine 10 has a stator 12 and a rotor 13 connected to a shaft 14 via a gearbox 15 such that movement of the fluid 8 in the direction of arrow A causes rotation of the rotor 13 which in turn causes rotation of the shaft 14.

A first set of resilient bristles 16 is connected to the drive means 9, the bristles 16 extending generally perpendicularly to the shaft 14 when in an unstressed state, i.e. prior to insertion of the vehicle into the pipe 7. The first set of resilient bristles 16 together with the body of the vehicle on which it is supported has an external diameter slightly greater than the internal diameter of the pipeline so that the bristles 16 engage the surface of the pipe 7.

The conduit gripping apparatus 1 is connected to the drive means 9 such that the shaft 14 is connected to the reverse traverse screw 50 of the conduit gripping apparatus 1 at the mating surface denoted by 17, and rotation of the shaft 14 causes rotation of the reverse traverse screw 50. The four surface engaging elements 3 are divided into two pairs, 31 and 32 (the second element of pair 32 not being shown). The surface engaging elements 3 of each pair 31, 32 share the same phase relationship with one another in their reciprocating motion along guide rail 5, but the pairs 31, 32 are half a cycle out of phase with each other.

The operation of the vehicle 6 described with reference to FIGS. 2a to 2d and FIG. 3 will now be described.

Referring specifically to FIGS. 2a and 3, fluid flows in the direction of arrow A and movement of fluid through the stator 12 causes rotation of the turbine rotor 13, which in turn causes rotation of the shaft 14. This in turn causes rotation of the reverse traverse screw 50, as a result of which the thread followers 53 engaging each surface engaging element 3 engage one of the grooves 51, 52 of the reverse traverse screw 50 to cause each pair of surface engaging elements 31, 32 to slide longitudinally relative to the housing of the conduit gripping apparatus 1.

Referring now to FIG. 2b, it can be seen that the surface engaging elements 3 have advanced through one quarter of a cycle of full reciprocation, and the first pair of surface engaging elements 31 are moving rearwardly in the direction of arrow B, whereas the second pair of surface engaging elements 32 is moving forwardly in the direction of arrow C.

Because bristles 41 on the first pair of surface engaging elements 31 are oriented backwards relative to the direction of travel of the vehicle 6, the frictional force of the bristles 41 against the wall of the pipe 7 is greater in the rearward direction than in the forward direction. Accordingly, the conduit gripping apparatus 1 is urged forwards. The first set of resilient bristles 16 also have greater resistance to moving backwards than forwards, and so they are also urged forwards and accordingly the vehicle 6 advances along the pipe.

At the same time, bristles 42 on the second pair of surface engaging elements 32 slide forwardly along the pipe. However, as the bristles 42 are also oriented backwards relative to the direction of motion of the vehicle, the frictional force exerted in the opposite direction to the motion of the vehicle is less than the combined rearwards frictional force of the first set of resilient bristles 16, and the bristles 41 mounted on the first pair of surface engaging elements 31. Consequently, the forwards motion of the bristles 32 along the pipe wall 7 does not impede the forward motion of the vehicle.

Referring now to FIG. 2c, where the surface engaging elements 31, 32 have completed one half of a complete cycle of reciprocation, as each surface engaging element 31, 32 reaches the end of its travel along the reverse traverse screw 50, the corresponding thread follower 53 is so shaped that its blade 154 moves from one of the grooves 51, 52 to the other so as to move in the opposite direction relative to the housing of the conduit gripping apparatus 1. This means that the bristles 41 mounted on the first pair of surface engaging elements 31 will begin to move forwardly along the conduit gripping apparatus 1, and the bristles 42 mounted on the second pair of surface engaging elements 32 will begin to move rearwardly.

Referring to FIG. 2d, where the surface engaging elements 31, 32 have completed three quarters of a full cycle of reciprocation, the first pair of surface engaging elements 31 are now moving forwardly in the direction of arrows D, while the second pair of surface engaging elements 32 move rearwardly in the direction of arrow E. In this configuration, the second pair of surface engaging elements 32 are now providing the traction force required to propel the vehicle along the pipe. When each pair of surface engaging elements 31, 32 reaches the end of its travel along the reverse traverse screw 50, one full reciprocation is complete and the vehicle is then back in the configuration shown in FIG. 2a. The process then repeats itself.

It can be seen then that at all times throughout the motion of the surface engaging elements 31, 32, at least one pair of surface engaging elements is moving rearwardly, and therefore providing traction to propel the vehicle 6. In the first half phase the traction force is provided by the first pair of surface engaging elements 31, and in the second half phase the traction force is provided by the second pair of surface engaging elements 32. The vehicle 6 therefore proceeds along the pipe at generally constant velocity.

The conduit gripping apparatus 1 is not limited to having two pairs of surface engaging elements operating 180° out of phase. In the embodiment shown in FIGS. 3 and 4, in which parts common to the embodiment of FIGS. 1 and 2 are denoted by like reference numerals but increased by 100, the conduit gripping apparatus 101 has three pairs of surface engaging elements 103 operating 120° out of phase of one another, and further embodiments may comprise four or more pairs of surface engaging elements. It will also be appreciated that there is no requirement for the surface engaging elements to operate in pairs with a shared phase relationship. Individual surface engaging elements can operate without being in phase with any of the others, provided at least one is providing the forward tractive force required for propulsion.

It will be appreciated by persons skilled in the art that the above embodiment has been described by way of example only and not in any limitative sense, and that various alterations and modifications are possible without departure from the scope of the invention as defined by the appended claims.

1. A conduit gripping apparatus for a vehicle travelling along a conduit having fluid flowing therein, the apparatus comprising:
a body; and
a plurality of surface engaging elements, wherein each said surface engaging element is adapted to engage a surface of the conduit and resist relative movement of the element and the surface of the conduit in a first direction along the conduit more than in a second direction opposite to said first direction;
wherein each said surface engaging element is adapted to execute reciprocating movement, relative to the body, having a component substantially parallel to said first and second directions, and not all of said surface engaging elements execute said reciprocating movement in phase with each other, and wherein said surface engaging elements remain in contact with the surface of the conduit during said reciprocating movement.

2. An apparatus according to claim 1, wherein a plurality of said surface engaging elements are provided with a plurality of resilient members.

3. An apparatus according to claim 2, wherein a plurality of said resilient members are bristles.

4. An apparatus according to claim 2, wherein a plurality of said resilient members are of elastomeric material.

5. An apparatus according to claim 2, wherein said resilient members extend, when in an unstressed state, substantially perpendicularly to the direction of movement of the vehicle.

6. An apparatus according to claim 1, wherein a plurality of said surface engaging elements are adapted to execute said reciprocating movements in a direction substantially parallel to an axis of the body.

7. An apparatus according to claim 5, further comprising a shaft rotatably mounted to and engaging said surface engaging elements, such that rotation of the shaft relative to the body in use causes said reciprocating movement.

8. An apparatus according to claim 7, further comprising at least one engaging member provided on one of said shaft and a respective said surface engaging element, and at least one groove provided on the other of said shaft and said surface engaging element, wherein rotation of said shaft relative to said surface engaging elements causes movement of the or each said engaging member along the corresponding said groove to cause said reciprocating movement of the corresponding said surface engaging element.

9. An apparatus according to claim 1, wherein a plurality of said surface engaging elements are retractable relative to the body.

10. An apparatus according to claim 9, further comprising at least one cam for retracting said retractable elements.

11. An apparatus according to claim 1, wherein throughout the reciprocating motion, approximately half of said elements are moving in said first direction and approximately half in said second direction relative to the body.

12. An apparatus according to claim 1, wherein at least one said surface engaging element executes said reciprocating movement along a substantially straight line.

13. (canceled)

14. A vehicle for travelling in a conduit having fluid flowing therein, the vehicle comprising:
at least one conduit gripping apparatus according to claim 1;
at least one drive apparatus having a shaft adapted to be rotated relative to the or each said body as a result of flow of fluid relative thereto;
at least one first surface engaging device mounted to the shaft for engaging a surface of the conduit and applying a gripping force thereto, such that said gripping force movement of the or each surface engaging device relative to the conduit more in one of said first or second direction than in the other of said first or second direction; and
at least one connector device for causing said reciprocating movement of said surface engaging elements as a result of rotation of the shaft relative to the or each said body.

15. A vehicle according to claim 14, wherein the vehicle derives the energy needed to propel itself from the fluid flow itself.

16. A vehicle according to claim 15, wherein at least one said drive apparatus includes at least one turbine.
